(19) United States
(12) Patent Application Publication
(10) Pub. No.: US 2018/0361980 A1
(43) Pub. Date: Dec. 20, 2018

(54) WEDGE SHAPED DRIVER AIRBAG WITH SPLIT

(71) Applicant: AUTOLIV ASP, INC., OGDEN, UT (US)

(72) Inventors: DAVID SCHNEIDER, Waterford, MI (US); CHRISTINA MORRIS, Auburn Hills, MI (US); JAMES JACOBSON, Waterford, MI (US)

(73) Assignee: AUTOLIV ASP, INC., OGDEN, UT (US)

(21) Appl. No.: 15/623,651

(22) Filed: Jun. 15, 2017

(51) Int. Cl. B60R 21/231; B60R 21/203

(52) U.S. Cl. CPC B60R 21/231; B60R 21/203

(57) ABSTRACT

An airbag is configured to be coupled to a steering wheel of a motor vehicle. The airbag includes a first panel and a second panel. The first panel is coupled to the second panel to form a split at a bottom area of the airbag forming two or more legs. The two or more legs cooperate to reduce the thickness of the airbag in a lower region upon inflation of the airbag as compared with an upper region of the airbag which interacts with the head and upper torso of an occupant.

### TECHNICAL FIELD

This disclosure relates to airbags for use in motor vehicles.

### BRIEF SUMMARY

While previous driver side airbags, particularly those formed from a pair of fabric panels having an identical outline shape have generally proven effective, it has been found that modified three-dimensional shapes for the inflated airbag can enhance performance. For example, typical driver side airbags have a generally pillow shaped configuration and are rotationally symmetric about the steering wheel axis of rotation. Such airbags extend a distance from the steering wheel in the deployed position that is the same at an upper portion that corresponds to an area at which an occupant's head might impact the airbag and a lower portion at which an occupant's chest or torso might impact the airbag. The occupant's head, however, will travel a greater distance than the occupant's chest or torso before reaching the airbag and its controlled deceleration. Earlier engagement with the occupant's head and upper torso is believed to provide opportunities for enhanced occupant protection.

Therefore, there exists a need for a driver's-side airbag that will better accommodate an occupant's anatomy and occupant protection dynamic factors with a goal of reducing loads acting on the occupant's head and chest.

Embodiments of the disclosed invention include an airbag configured to be coupled to a steering wheel of a motor vehicle. The airbag includes a first panel and a second panel. The first panel is coupled to the second panel to form a split at a bottom area of the airbag forming two or more legs. The two or more legs cooperate to reduce the thickness of the airbag in a lower region upon inflation of the airbag as compared with an upper region of the airbag which interacts with the head and upper torso of an occupant.

Another embodiment of the disclosed invention includes an airbag configured to be coupled to a steering wheel of a motor vehicle. The airbag includes a first panel and a second panel having an identical perimeter shape to the first panel are coupled together around a perimeter of the first panel and the second panel. The first panel and the second panel include a plurality of legs that form a split at a bottom area of the airbag. A first depth extends from the first panel to the second panel proximate an upper region when the airbag is in the deployed position. At least a second depth extends from the first panel to the second panel proximate a lower region. The second depth is less than the first depth.

Each embodiment of the present invention provides an asymmetric geometry top to bottom that can be created by the difference in airbag panel width relative to the top and the bottom of the airbag and/or by providing a split at the bottom of the airbag. These shapes are accomplished without requiring tethers or separate side panels to create the wedge shape (deep at top, shallow at bottom). The height of the split as well as the geometry (width, angles, non-inflated region) of the split, result in a reduced depth in the lower portion of the inflated airbag.

Other systems, methods, features and advantages of the invention will be, or will become, apparent to one with skill in the art upon examination of the following figures and detailed description. It is intended that all such additional systems, methods, features and advantages be within the scope of the disclosure, and be encompassed by the following claims.

### BRIEF DESCRIPTION OF THE DRAWINGS

FIG. 1 is a side view of an occupant and an embodiment of the airbag in accordance with the present invention in a deployed position;

FIG. 2 is a top view of a panel of the airbag of FIG. 1;

FIG. 3 is a side view of the airbag of FIG. 1 in a deployed position; and,

FIG. 4 is a front view of the airbag of FIG. 1 in a deployed position.

### DETAILED DESCRIPTION

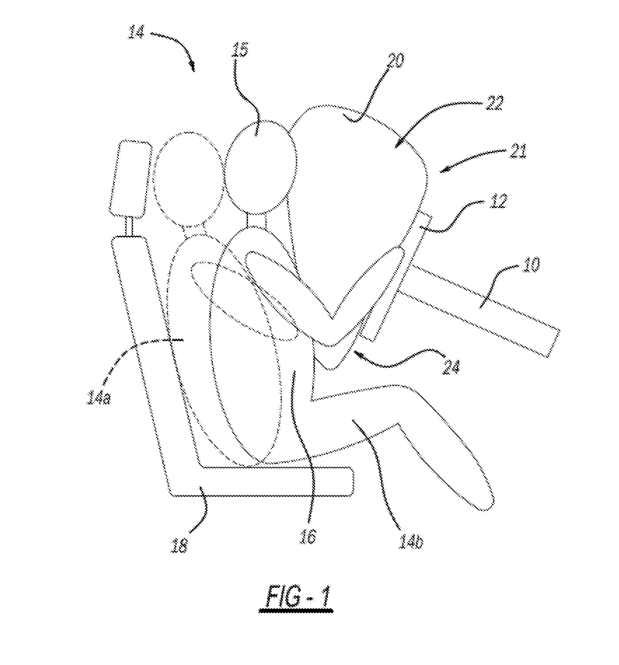

FIG. 1 illustrates an environment in which various embodiments of the invention are used. Illustrated is an interior portion of a motor vehicle that includes a steering column 10 and a steering wheel 12. Other components of the motor vehicle are omitted for clarity. Of course, embodiments of the invention may be used in any type of vehicle or application.

An occupant 14 of the motor vehicle is seated in a seat 18. The occupant 14 is illustrated in broken lines as he or she would appear in a normal position 14a and in unbroken or solid lines in a collision position 14b during which an airbag 20 is activated and as illustrated in the airbag's deployed position 21. During a collision sufficient to activate the airbag 20, the occupant's head 15 and chest or torso 16 may interact with one or more portions of the airbag 20. While the airbag 20 is illustrated for use in driver's position in a motor vehicle, the airbag 20 may be used in other seating positions of the motor vehicle, such as a passenger seat, rear seats, or for side impact protection (side and curtain airbags).

The airbag 20 has a wedge shape in which the airbag 20 has a greater depth or thickness at an upper portion or upper region 22 of the airbag 20 than at a lower portion or lower region 24 of the airbag. The airbag 20 with its wedge shape may advantageously provide earlier and greater restraint and reduced angular velocity of the occupant's head 15, which may reduce the head or brain injury criteria (BrIC) for a given collision. BrIC is a measure intended to be related to the likelihood that the occupant would suffer a head or brain injury during the collision.

As will be explained in greater detail below, the three-dimensional wedge shape of the airbag 20 is created with a single panel or two or more panels of material coupled together at the perimeter/periphery or the peripheral edges of the panel or panels. The depth, height, and width of the airbag 20 are controlled by varying the geometry of the single panel or one or more of the panels that form the airbag 20. In other words, and in contrast to the prior art, the construction of the airbag 20 does not require separate side panels to achieve the desired 3-dimensional or wedge shape of the airbag 20 in its deployed position 21.

In addition, the wedge shape of the airbag 20, with the reduced depth at the lower portion or lower region 24, may result in less interaction, less loading, and less deflection of the chest or torso 16 of the occupant 14. This, in turn, may reduce the risk of injury to the occupant's chest or torso 16 during a collision.

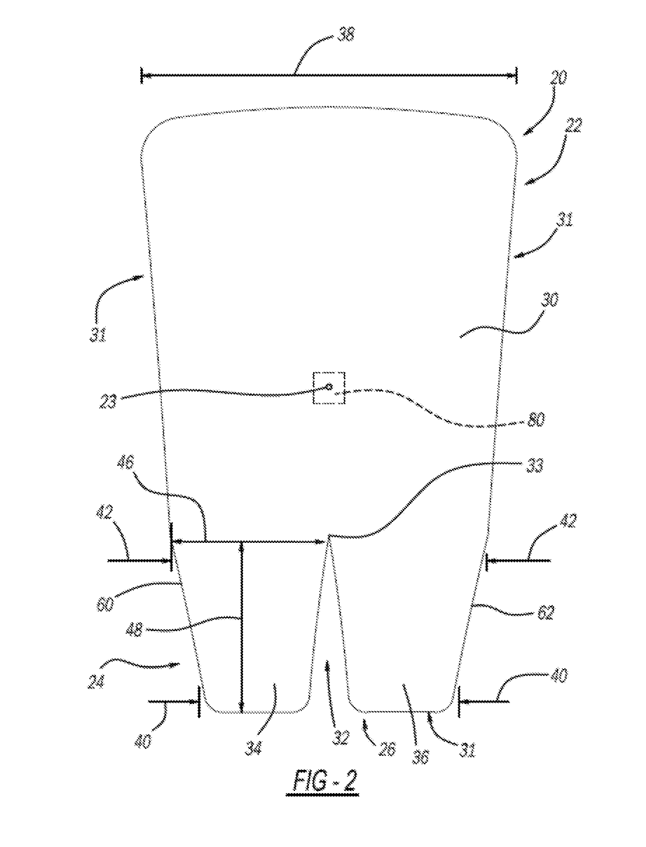

FIGS. 2-4 illustrate various features of the airbag 20. The airbag 20 is formed from at least one and, in some embodiments, two or more panels. Thus, while reference will be made to two panels in the following discussion, it is to be understood that the two panels may simply refer to separate portions of a contiguous or integral panel. Further, the panel or panels may be symmetric or asymmetric about one or more axes.

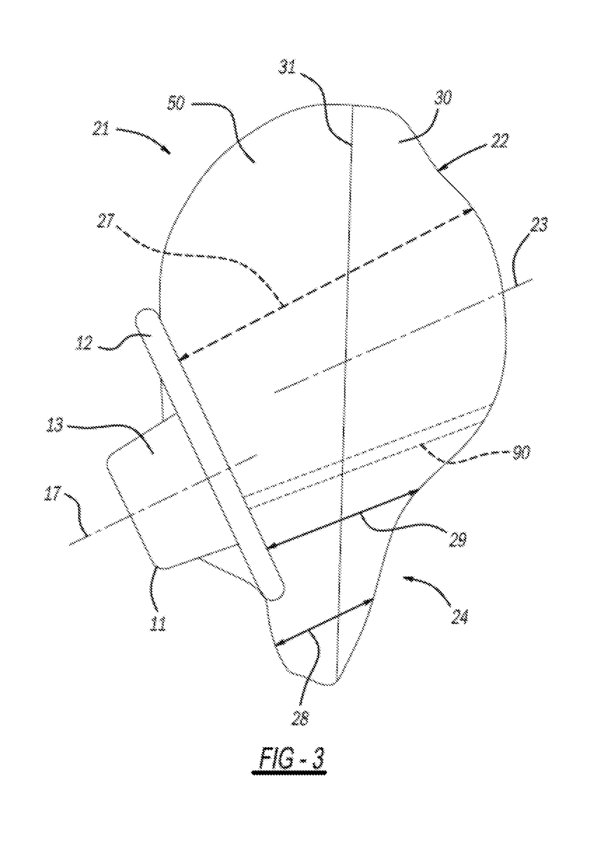

The airbag 20 is configured to be coupled to a steering wheel 12 of a motor vehicle. Optionally, the airbag 20 is configured to be coupled to, housed, or stored in an airbag housing 13 as illustrated in FIG. 3. The airbag housing 13 stores the airbag 20 when the airbag 20 is in its undeployed position (not illustrated), i.e., before a collision. The airbag housing 13 optionally includes a cover (not illustrated) that faces the occupant 14 during normal operating conditions. The airbag housing 13 optionally includes creases, seams, split lines, or other features that are designed to split or open when the airbag 20 activates, expands, and deploys during a collision.

Typically the airbag housing 13 would be fixed to and rotatable with the vehicle's steering wheel and thus its rotational position is controlled by the driver's movement of the steering wheel. Optionally, the airbag 20 may then be shaped and have a geometry that may enhance the protection of the occupant when the airbag is deployed regardless of the orientation of the airbag 20 at the time of deployment.

Additionally or alternatively, the airbag housing 13 optionally may be configured to couple to or be coupled to a non-rotating hub 11, as illustrated in FIG. 3. As noted, the airbag 20 has a wedge-shaped profile intended to potentially enhance head and chest protection during a collision. The wedge-shape of the airbag 20, however, may better provide those benefits when the upper portion 22 is oriented or otherwise substantially aligned with the occupant's head 15 and the lower portion 24 is oriented or otherwise substantially aligned with the occupant's chest or torso 16. A non-rotating hub 11 helps to maintain the orientation of the airbag house 13 and the airbag 20 relative to the occupant 14 regardless of the orientation of the steering wheel 12 during a collision. In other words, the non-rotating hub 11 prevents the airbag housing 13 and the airbag 20 from rotating with the steering wheel 12. Thus, in the event a collision occurs when the steering wheel 12 is rotated, such as when an occupant or driver 14 is attempting to avoid the collision by making an evasive maneuver or turn, the non-rotating hub 11 allows the airbag 20 to still be properly oriented with respect to the occupant's head 15 and chest or torso 16. However, when used with conventional rotating hubs the airbag 20 provides benefits since a normal straight-ahead orientation of the steering wheel and therefore upright position of the airbag is normally true in vehicle operation and collisions.

As illustrated best in FIG. 3, the airbag 20 optionally is not centered on the airbag housing 13 when the airbag 20 is in a deployed condition 21. In other words, the airbag 20 is not centered top-to-bottom on the steering wheel 12. Optionally and as illustrated in FIG. 3, a centerline 17 of the airbag housing 21 is not coincident with a centerline 23 of the airbag 20. In this eccentric or not centered configuration, the airbag 20 may provide greater depth and/or additional coverage for the occupant's head 15 and upper torso than the prior art.

The airbag 20 also optionally includes an inflator 80 coupled to one the panels that make up the airbag 20.

The airbag 20 includes a first panel 30 and a second panel 50. The first panel 30 is coupled to the second panel 50 to form a split 32 at a bottom area 26 of the airbag 20. The split 32 defines or forms at least a plurality of legs 34, 36. The at least a plurality of legs optionally may be two legs or more than two legs.

The two or more legs 32, 34 cooperate to reduce the thickness of the airbag 20 in a lower portion or lower region 24 upon inflation of the airbag 20 as compared with an upper portion or upper region 22 of the airbag which interacts with the head 15 and upper torso 16 of an occupant 14.

Stated differently, the airbag 20 includes a first depth 27 extending from the first panel 30 to the second panel 50 proximate an upper portion or upper region 22 when the airbag 20 is in the deployed position 21 and at least a second depth 28 extending from the first panel 30 to the second panel 50 proximate a lower region 24. Optionally, the second depth 28 is less than the first depth 27. This configuration with the split 32, then, may also provide the airbag 20 with greater depth and/or additional coverage for the occupant's head 15 and upper torso than the prior art.

The airbag 20 may also include a third depth 29 extending from the first panel 30 to the second panel 50 at a position between the first depth 27 and the second depth 28. In some embodiments, the third depth 29 is less than the first depth 27 and greater than the second depth 28.

The first panel 30 and the second panel 50 include a first width 38 in the upper region 22 and a second width 40 in the lower region, wherein the first width 38 is greater than the second width 40. The greater width 38 in the upper region 22 may enhance head coverage and/or create additional or greater thickness in the upper region 22 or increase the first depth 27.

The first panel 30 and the second panel 50 may be generally rectangular, square, triangular, or other such shapes. In some embodiments, the first panel 30 and the second panel 50 optionally have an identical perimeter shape 31. For example, the perimeter shapes 31 of the first panel 30 and the second panel 50 are generally rectangular with the split 32 formed in the lower portion or lower region 21 of the rectangular shape. Further, the second panel 50 includes some or all of the same features identified in the illustration of the first panel 30 in FIG. 2 and, consequently, these features and element numbers will be understood to refer to features that optionally are common to both the first panel 30 and the second panel 50.

The first panel 30 and the second panel 50 may be formed of separate pieces of a base material that is coupled together around the periphery or perimeter 31 of the first panel and the second panel 50. Alternatively, the first panel 30 and the second panel 50 are formed of a contiguous piece of the base material that is folded over to form at least a portion of the perimeter 31 about which the first panel 30 and the second panel 50 are coupled.

The base material from which the first panel 30 and the second panel 50 are made may be any type of material that typically is used to form airbags. The first panel 30 and the second panel 50 may be coupled or affixed about the periphery or perimeter 31 by stitching, welding, adhesives, or other methods of coupling airbag panels together.

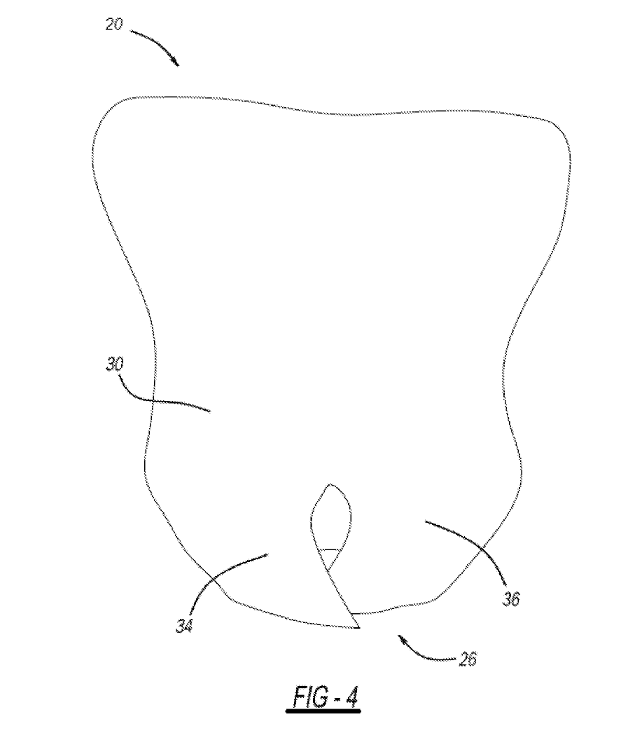

Referring back to the two or more legs 34, 36, they optionally may be separated by the split 32 when the airbag 20 is in the deployed position, i.e., the legs 34, 36 do not overlap (not illustrated) or, alternatively and as illustrated in FIG. 4, the two or more legs 34, 36 may at least partially overlap when the airbag 20 is in the deployed position 21.

In addition, the two or more legs 34, 36 optionally may taper from a third width 42 to the second width 40, wherein the third width 42 is greater than the second width 40. The first width 38 may be less than, the same, or greater than the third width 42, the last of which is illustrated in FIG. 2. The tapered configuration of the two or more legs 34, 36, may further reduce the depth 28 in the lower portion or lower region 24 of the airbag 20.

Each of the two or more legs 34, 36 may also optionally have a leg width 46 that extends laterally when viewed in FIG. 2 from a side of the perimeter/periphery 31 to a root 33 of the split 32. Similarly, each of the two or more legs 34, 36 may also optionally have a leg height 48 that extends vertically when viewed in FIG. 2 from the perimeter/periphery 31 to a root 33 of the split 32. The leg width 46 may be less than the leg height 48, as illustrated in FIG. 2, or the leg width 46 may instead be equal to or greater than the leg height 48. Furthermore, the leg height 48 optionally may be any ratio either greater or smaller than the leg width 46. For example, the leg height 48 may be any multiple of the leg width 46, such as one and one-half, two, three, or more times the leg width 46. In the example in which the leg height 48 is one and one-half the leg width 46, in the event the leg width 46 is 20 cm (7.9 inches), the leg height 48 is approximately 30 cm (11.8 inches). Thus, in some embodiments, the leg height 48 falls within a ratio of leg width 46 from less than 1 (i.e., the leg height 48 is less than the leg width 46) to more than 10 (i.e., the leg height 48 is greater than the leg width 46). Presented as a formula for those embodiments in which the leg height 48 is greater than the leg width 46, the (leg width 46) (leg height 48) 10*(leg width 46).

In addition, for those embodiments in which the leg width 46 is less than the leg height 48, the depth 28 in the lower portion or lower region 24 of the airbag 20 may be correspondingly smaller than would otherwise be achievable in the prior art. In other words, the depth 28 is a function, in part, of the leg height 48 relative to the leg width 46.

Optionally, the airbag 20 includes one or more tethers 90 that couple one or more of the first panel 30 to the second panel 50 in a front-to-rear (i.e., occupant-to-steering wheel) direction, as illustrated in FIG. 3 and/or the tethers may be positioned in a left-to-right direction (not illustrated). The tethers 90 are positioned internally to the first panel 30 and the second panel 50.

The airbag 20 also optionally includes one or more diffusers (not illustrated) positioned internally within the airbag 20.

The airbag 20 also optionally includes one or more portions (not illustrated) that are not inflated when the airbag 20 otherwise is in the deployed position 21. The airbag 20 may also include one or more vent holes (not illustrated) so as to permit the airbag 20 to deflate.

Methods of forming the various embodiments of the airbags as would be understood and apparent to one of skill in the art also fall within the scope of the disclosure.

While particular elements, embodiments, and applications of the present invention have been shown and described, it is understood that the disclosure is not limited thereto because modifications may be made by those skilled in the art, particularly in light of the foregoing teaching. It is therefore contemplated by the appended claims to cover such modifications and incorporate those features which come within the spirit and scope of the disclosure.

1. An airbag configured to be coupled to a steering wheel of a motor vehicle, the airbag comprising:
a first panel;
a second panel;
the first panel being coupled to the second panel to form a split at a bottom area of the airbag forming two or more legs, the two or more legs cooperating to reduce the thickness of the airbag in a lower region upon inflation of the airbag as compared with an upper region of the airbag which interacts with the head and upper torso of an occupant.

2. An airbag in accordance with claim 1, further comprising the first panel and the second panel having an identical perimeter shape and formed of separate pieces of base material which are coupled together around a perimeter of the first panel and the second panel.

3. An airbag in accordance with claim 1, further comprising the perimeter shapes of the first panel and the second panel being generally rectangular with the split formed in a lower portion of the rectangular shape.

4. The airbag of claim 1, further comprising an airbag housing configured to receive and to store the airbag when the airbag is in an undeployed condition.

5. The airbag of claim 4, further comprising a non-rotating hub configured to couple to the airbag housing.

6. The airbag of claim 1, wherein the two or more legs at least partially overlap when the airbag is in the deployed position.

7. The airbag of claim 1, further comprising an inflator coupled to the rear panel.

8. The airbag of claim 1, wherein the first panel and the second panel include a first width in the upper region and a second width in the lower region, wherein the first width is greater than the second width.

9. The airbag of claim 11, wherein the two or more legs taper from a third width to the second width, wherein the third width is greater than the second width.

10. The airbag of claim 12, wherein the first width is greater than the third width.

11. The airbag of claim 1, wherein the first panel and the second panel are formed of a contiguous piece of a material folded over to form at least a portion of a perimeter about which the first panel and the second panel are coupled.

12. The airbag of claim 5, wherein the airbag is not centered on the airbag housing when the airbag is in a deployed condition.

13. An airbag configured to be coupled to a steering wheel of a motor vehicle, the airbag comprising:
a first panel and a second panel having an identical perimeter shape which are coupled together around a perimeter of the first panel and the second panel, the first panel and the second panel including a plurality of legs that form a split at a bottom area of the airbag;
a first depth extending from the first panel to the second panel proximate an upper region when the airbag is in the deployed position and at least a second depth extending from the first panel to the second panel proximate a lower region, wherein the second depth is less than the first depth.

14. The airbag of claim 13, wherein the first panel and the second panel are formed of separate pieces of base material.

15. The airbag of claim 13, further comprising a third depth extending from the first panel to the second panel at a position between the first depth and the second depth, wherein the third depth is less than the first depth and greater than the second depth.

16. An airbag in accordance with claim 13, further comprising the perimeter shapes of the first panel and the second panel being generally rectangular with the split formed in a lower portion of the rectangular shape.

17. The airbag of claim 13, further comprising an airbag housing configured to receive and to store the airbag when the airbag is in an undeployed condition.

18. The airbag of claim 17, further comprising a non-rotating hub configured to couple to the airbag housing.

19. The airbag of claim 1, wherein the first panel and the second panel include a first width in the upper region and a second width in the lower region, wherein the first width is greater than the second width.

20. The airbag of claim 19, wherein the plurality of legs taper from a third width to the second width, wherein the third width is greater than the second width.
